(19) United States
(12) Patent Application Publication
(10) Pub. No.: US 2009/0164449 A1
(43) Pub. Date: Jun. 25, 2009

(54) SEARCH TECHNIQUES FOR CHAT CONTENT

(75) Inventor: Jeff Huang, Sunnyvale, CA (US)

Correspondence Address: Weaver Austin Villeneuve & Sampson - Yahoo!, P.O. BOX 70250, OAKLAND, CA, 94612-0250, US

(73) Assignee: Yahoo! Inc.

(21) Appl. No.: 11/961,890

(22) Filed: Dec. 20, 2007

(51) Int. Cl. G06F 17/30

(52) U.S. Cl. 707/5; 707/E17.084

(57) ABSTRACT

Methods and apparatus are described for generating a searchable body of data representing a plurality of communications, and for facilitating searching of such a body of data.

### BACKGROUND OF THE INVENTION

The present invention relates to search techniques for bodies of data which include representations of real-time communications between parties, and more specifically to techniques for making chat room content searchable.

Sophisticated search tools for identifying relevant online content have been available on the Web for some time and continue to evolve. Such search tools are an integral part of both the utilitarian and economic underpinnings of the World Wide Web.

Until recently, the content of the typical online chat room has not been interesting enough or valuable enough to archive or reference. More recently, chat rooms relating to highly specialized subject matter, e.g., technical chat rooms relating to various types of computer programming, have evolved in which content is communicated which is highly relevant and useful to users having an interest in the subject matter, e.g., programmers. However, attempts to archive such chat content in useful ways have typically involved efforts by individual users and have largely been ineffective.

For example, the chat content that is archived, e.g., in individual user logs, has only been searchable using the crudest of techniques, e.g., text string searching. With the volume of chat data (the two largest IRC networks each have over 100,000 users online at any given moment), such techniques are wholly ineffective at helping a user identify results which are relevant and useful.

### SUMMARY OF THE INVENTION

According to various embodiments of the present invention, methods and apparatus are described for generating a searchable body of data representing a plurality of communications, and for facilitating searching of such a body of data.

According to one embodiment, methods and apparatus are provided which enable searching of a body of data representing a plurality of communications, each of the plurality of communications being generated by an associated entity. A plurality of search results are identified with reference to a keyword search initiated by a user. Each search result corresponds to at least one of the communications. The search results are ranked with reference to at least one metric representing the associated entity who generated the corresponding communication. The ranked search results are presented to the user.

According to another embodiment, methods and apparatus are provided for generating a searchable body of data representing a plurality of communications. Each of the plurality of communications is recorded. For each of the plurality of communications, user metadata are generated identifying the associated entity who generated the corresponding communication, and including a score for the associated entity. The score represents an authority level of the associated entity in a context in which the corresponding communication was generated. The plurality of communications and the user metadata are indexed in a searchable data store.

According to yet another embodiment, methods and apparatus are provided which enable searching of a body of data representing a plurality of communications. A user is enabled to initiate a keyword search of the body of data. A plurality of ranked search results are is presented to the user. Each search result corresponds to at least one of the communications. The search results have been determined with reference to the keyword search, and ranked with reference to at least one metric representing the associated entity who generated the corresponding communication.

According to still another embodiment, at least one computer-readable medium is provided having a data structure stored therein. The data structure includes a plurality of data records. Each data record corresponds to a communication generated by an associated entity and includes at least a portion of the corresponding communication. Each data record also has user metadata associated therewith which identifies the associated entity who generated the corresponding communication, and includes a score for the associated entity. The score represents an authority level of the associated entity in a context in which the corresponding communication was generated. The data records are configured to be returned as search results, and the search results may be ranked with reference to the score for the associated entities.

A further understanding of the nature and advantages of the present invention may be realized by reference to the remaining portions of the specification and the drawings.

### BRIEF DESCRIPTION OF THE DRAWINGS

FIG. 1 is a block diagram of a Web based chat search system according to a specific embodiment of the invention.

FIG. 2 is a flowchart illustrating operation of a chat search system according to a specific embodiment of the invention.

FIG. 3 is an example of a log file format which may be employed with various embodiments of the invention.

FIG. 4 is an example of a search interface which may be employed with various embodiments of the invention.

FIG. 5 is a block diagram of a network environment in which embodiments of the invention may be implemented.

FIG. 6 is an example of a graphical user interface in which search results generated according to a specific embodiment of the invention are presented.

### DETAILED DESCRIPTION OF SPECIFIC EMBODIMENTS

Reference will now be made in detail to specific embodiments of the invention including the best modes contemplated by the inventors for carrying out the invention. Examples of these specific embodiments are illustrated in the accompanying drawings. While the invention is described in conjunction with these specific embodiments, it will be understood that it is not intended to limit the invention to the described embodiments. On the contrary, it is intended to cover alternatives, modifications, and equivalents as may be included within the spirit and scope of the invention as defined by the appended claims. In the following description, specific details are set forth in order to provide a thorough understanding of the present invention. The present invention may be practiced without some or all of these specific details. In addition, well known features may not have been described in detail to avoid unnecessarily obscuring the invention.

According to various embodiments of the invention, large volumes of communications, e.g., chat content, are recorded, indexed, and made searchable using scoring techniques developed to produce relevant and useful search results. It should be noted that this is a different problem than the conventional ranking of documents in standard web search results. For example, chat search results typically correspond to relatively short lines of chat rather than documents with large amounts of text. This makes data mining for content and classification difficult. In addition, and unlike most web documents, lines of chat do not typically include links to other lines of chat, and so may not generally be contextualized and ranked on that basis.

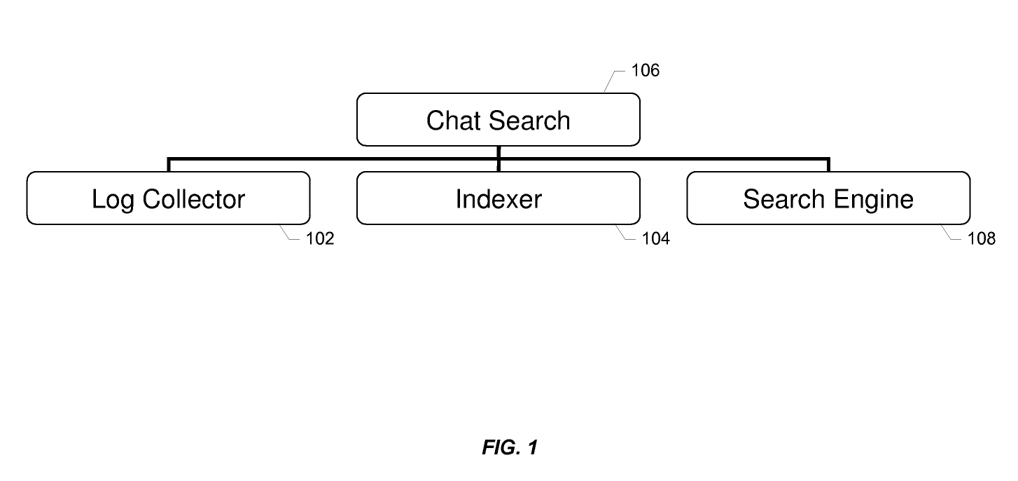

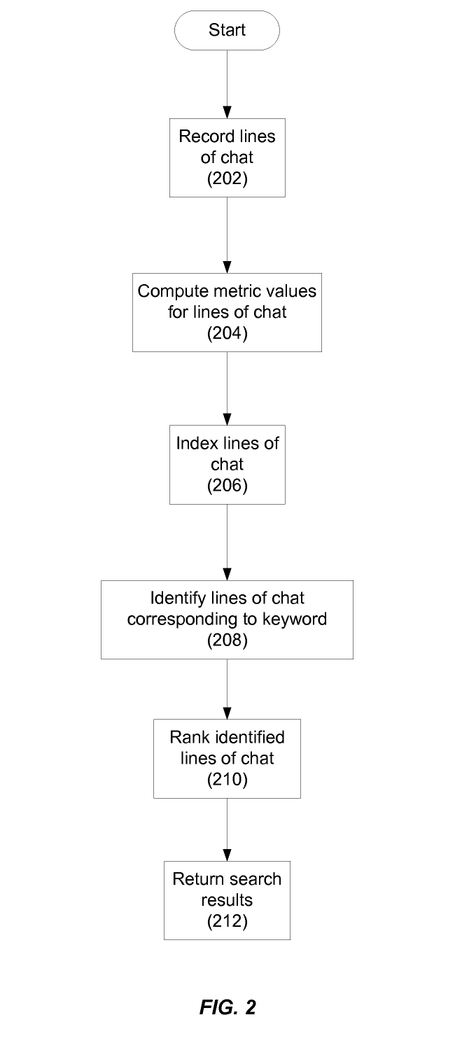

According to specific embodiments, and as illustrated in FIGS. 1 and 2, one or more processes (represented by Log Collector 102) record lines of chat generated in one or more chat rooms (202). An example of such a process is a passive robot or “bot” which remains connected to one or more chat rooms, and which automatically reconnects if it is disconnected.

The set of chat rooms from which chat content is recorded may be one specific chat room, a relatively small group of chat rooms (e.g., chat rooms operated by one entity or dealing with a specific topic), or an arbitrarily large number of chat rooms (e.g., virtually any set of chat rooms on the Web). The collected lines of chat are indexed, e.g., by Indexer 104. Recording and/or indexing can occur on a continuous basis (i.e., as each line of chat is posted), or on a more infrequent basis (e.g., every hour or few hours, once a day, etc.) as appropriate for a given application.

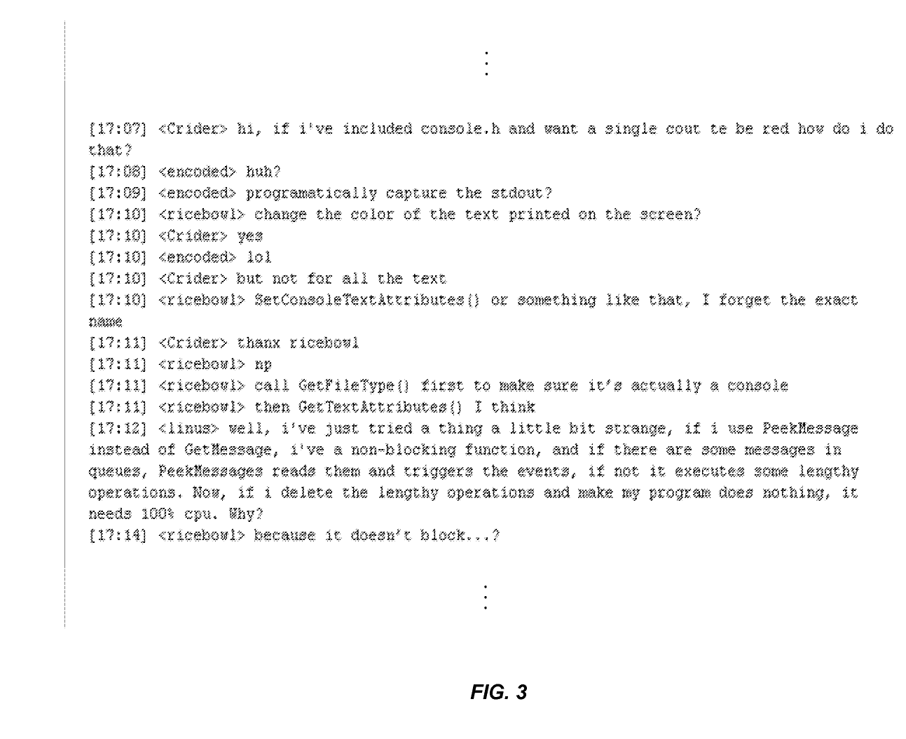

According to a specific embodiment, Log Collector 102 records all of the chat text into one or more log files using a format which includes a time stamp and an identifier for the user posting each line of chat, e.g., a user name. An example of such a log file format is shown in FIG. 3.

Indexer 104 then parses the log(s), computes various metric values (204), e.g., as described below, and indexes the data into a data store (206) using an inverted index which associates each token (e.g., words in a line of text separated by non-alphanumeric characters) with a file identifier (e.g., log ID) and a line identifier (e.g., time stamp). Line metadata and user metadata is associated with each line of chat. These metadata include metric values for the line and the user, respectively, which are used to rank the lines when returned as search results by Search Engine 108. These metadata may include the metrics described below, e.g., Readability, Prevalence, Goodwill, UserRank, etc., as well as any of a wide variety of similar metrics or conventional metrics which may be appropriate for a given application.

It will be understood that the nature of the data store and data structures employed to store a body of data in accordance with the invention may vary considerably without departing from the invention. For example, such data may be indexed in a database using a wide variety of data models and conventional and proprietary database tools. Alternatively, such a body of data may be stored using a compressed flat file as an index, e.g., using Lucene. Other suitable alternatives within the scope of the invention will be apparent to those of skill in the art.

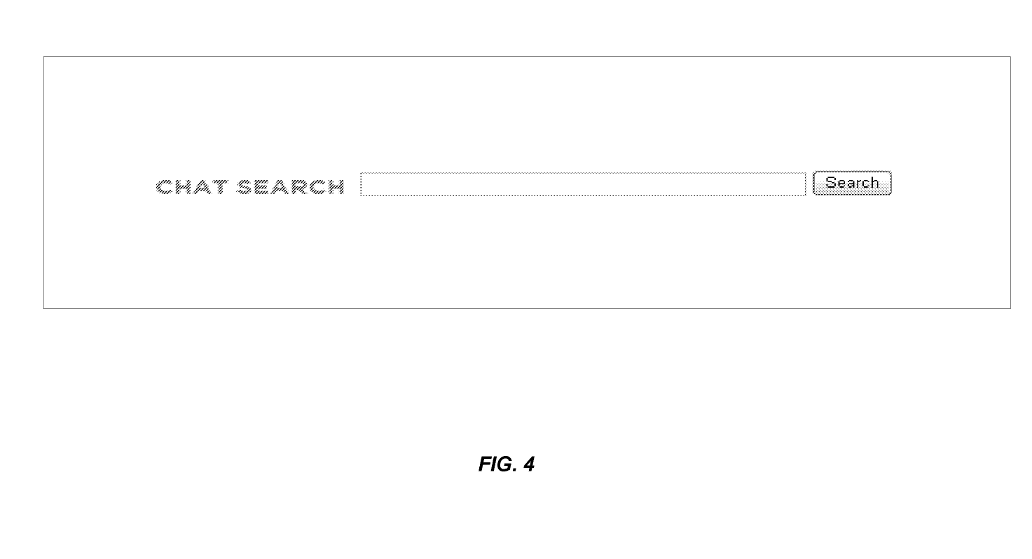

When a search is initiated using a specific keyword, e.g., via Chat Search Interface 106 an example GUI for which is shown in FIG. 4, lines of chat which include that keyword (or its derivative forms) are identified (208) and ranked (210), e.g., by Search Engine 108. The ranked search results are then returned to the searcher (212).

The search results correspond to (or at least include) specific lines of chat in a log file. Conventional ranking mechanisms may be used in addition to and in combination with the ranking metrics introduced herein to identify the most relevant and useful results. Such conventional mechanisms might include, for example, stemming (i.e., shortening a search term using wild cards), case match (i.e., a Boolean value for whether a search term has the same case as a matching term in a result), token position (i.e., a measure of how well the order of search terms match the order of terms in a result), etc.

In some cases, conventional mechanisms such as case match and token position may have relative significance in the context of chat data. For example, a search on “GetMessage” (a winapi function) should score lines that contain “GetMessage” higher than lines that contain “getMessage” or “getmessage” as the latter two text strings may refer to user-defined functions. Token (or word) position may also serve as an important cue. For example, searching for “file input” would score a line containing “file input” higher than a line containing “file binary input” or “input file.”

In addition to such conventional mechanisms, and according to various embodiments of the invention, lines of chat are also ranked with reference to one or more metrics which are reflective of the nature of the body of data being indexed, e.g., chat content, and/or the users who generate the data, e.g., chat room participants. And although specific embodiments are described in which at least some of these metrics are used to generate a UserRank score for a user generating lines of chat, scores based on at least some of these metrics may be generated with reference to specific lines of chat and used independently or in addition to UserRank. That is, a specific line of chat may be scored, for example, with reference solely to the content included in that line of chat. In addition, or alternatively, a line of chat may be scored based on who is speaking, i.e., with reference to one or more metric values associated with the user generating the line of chat. This latter concept is referred to herein as UserRank.

According to a specific embodiment, Readability is a metric which refers to how readable a line of chat is and may be determined with reference to any of a wide variety of quantitative metrics. For example, such metrics may include, but are not limited to automated readability index (ARI), spelling, grammar, punctuation, correct sentence formation, “grade level,” average word length, characters per line, alphabet to non-alphabet character ratio, etc. In some embodiments, Readability for a given user may be determined with reference to a body of chat from that user and incorporated into a UserRank score for that user. In other embodiments, Readability is scored with reference to a specific line of chat. In still other embodiments, both approaches may be used in some combination. Use of a readability metric helps to ensure that chat lines returned as search results are relatively articulate and not characterized as spam.

According to one implementation, average word length is considered such that when the average word length for a given chat line deviates significantly from some empirically determined value, e.g., 5 or 6 characters, the readability of the line may be considered low. Such might be the case, for example, where the generator of the chat line uses common messaging abbreviations or, alternatively, types in one or more lengthy URLs.

According to a specific embodiment, Prevalence is an aspect of UserRank and refers to the volume of chat from a specific user in a particular chat room or group of chat rooms, or with reference to particular subject matter. That is, for example, it is assumed that if a given user generates a high volume of chat relating to a particular topic, or is active on many days in a particular chat room, the user is more likely to be an authority or have expertise with respect to the relevant subject matter. In one set of implementations, Prevalence is calculated using a logarithmic function to avoid, for example, too heavily weighting an ultra-high-volume chatter relative to another lower-volume but still relatively high-volume chatter. For example, Prevalence may be calculated by applying a logarithmic function to the user's activity frequency as defined, for example, by the number of days the user is active in a chat room and/or the number of chat lines generated by the user.

According to a specific embodiment, Goodwill is a metric which refers generally to the character of chat lines in terms of qualities such as, for example, civility, helpfulness, etc. In some cases, Goodwill may be determined with reference to the surrounding lines. So, for example, if a chat line uses terms such as “you're welcome,” or replies to that line use terms such as “thanks” or “that works,” that line may score high in this metric. In another example, if a line of chat appears to be directly addressing other users (identified from surrounding chat lines), this may result in a positive contribution to the Goodwill score of that line. In another example, a chat line which includes a URL may be considered to be helpful in that it is likely to be intended to point another user in the direction of a requested or needed resource. According to a specific embodiment, Goodwill for a given user may be derived from a body of chat lines generated by that user, e.g., an average of the Goodwill scores from individual lines of chat generated by that user. However, as noted above, embodiments are contemplated in which a Goodwill score for a specific line of chat may be used to rank that line with or without reference to the Goodwill of the user.

According to a specific embodiment, the Goodwill for a given user may be determined with reference to relationships between the user and other users. For example, the social network of an Internet Relay Chat (IRC) channel can be shown as a graph, with nodes representing users and edges representing connections between the users. Direct addressing, temporal proximity, and temporal density can be used to identify such connections. Inferences from these connections, e.g., strength and number of relationships can then be used to generate positive or negative contributions to a particular user's Goodwill score. For a more detailed description of techniques suitable for identifying such connections, see Inferring and Visualizing Social Networks on Internet Relay Chat, Paul Mutton, Proceedings of the Eighth International Conference on Information Visualisation (IV'04), the entirety of which is incorporated herein by reference for all purposes.

According to a specific embodiment, the context in which a line of chat is generated may be used in the ranking process. That is, the context may be important in determining the relevancy or quality of a given search result. For example, if a user initiates a search using the term “Python string functions,” lines of chat generated in a chat room in which the official topic is the Python programming language may be ranked more highly than equivalent lines of chat generated in chat rooms not specifically related to Python.

According to various embodiments, the “user” or entity generating lines of chat may include both human users and automated processes. For example, it is contemplated that lines of chat might be generated by bots rather than human users, and yet may be the most relevant and useful results to a particular search. For example, a user might initiate a chat content search requesting information with respect to a specific technical term of art, in response to which a bot associated with the chat room (e.g., put in place by the chat room operator) generates a line of chat (typically previously generated) which defines the term and/or provides links to resources relating to the term. Such lines of chat are often considered to be quite useful and typically rank high in at least some of the metrics described herein. As a result, such a bot might have a high UserRank even though it is not human.

The various metrics described above (as well as other user metrics) may be weighted and combined in any of a wide variety of ways to generate a UserRank score which may then be employed to rank lines of chat in response to a search of chat content. For example, Prevalence has been shown to be an important metric and so may be weighted more heavily than others when combining the metrics.

According to some embodiments, UserRank is pre-computed for users in a given chat room or group of chat rooms and is used subsequently to rank lines of chat. This avoids slowing down the ranking of search results that might otherwise be caused by calculating UserRank on the fly. As will be understood, these UserRank values may be recomputed over time using any arbitrary interval to account for changes in user behavior and/or the inclusion of new users.

In some cases, the line of chat containing a keyword may not necessarily be the best result in response to a search using that keyword. That is, the lines of chat around that line of chat may turn out to be more useful or relevant to the user than the identified line. Therefore, according to some embodiments, the lines of chat which occur in the chat room around or near the line of chat containing a search keyword, i.e., the context of the line of chat, are either included as part of the search result or made accessible via the search result. This approach may have multiple benefits.

First, there are situations in which the line of chat containing the keyword is actually a question about the keyword rather than useful information. In such a situation, a more useful line of chat will be the subsequent response from someone with a high UserRank, i.e., someone with expertise or authority in that context. Second, associating more than one line of chat with a single search result may have the benefit of reducing the overall number of results and, in particular, avoiding the redundancy of representing the lines of chat which are part of a single conversation as individual results.

The context of the line of chat may include any arbitrary number of lines above and below the specific line of chat which includes the keyword. Embodiments are even contemplated in which the number of lines included is determined with reference to information about the lines of chat themselves. For example, the context might be cut off at or near the point at which the user who generated the line of chat including the keyword is no longer included among the chat entries.

According to a specific embodiment, the search result actually provides access to a representation of the original context of the line of chat (e.g., as stored in a chat log file) so that the searcher can scroll up and down from that line indefinitely. This allows the searcher to browse the entire context in which the line of chat originated, and to potentially identify further relevant and useful information.

A line of chat may also be repeated within a particular chat room, sometimes many times. This might be the case, for example, where an expert user or a bot responds to a commonly posed question with the same body of text. Therefore, according to some embodiments, such duplicate entries are detected and collapsed into a single search result from which the various lines of chat and/or contexts in which the text appears may be accessed. According to one embodiment, the duplicate results are detected with reference to a hash value (e.g., using an MD5 hashing function) recorded for the original result. That is, each search result returned has an MD5 value calculated. The hash values for subsequent results are compared to earlier results to identify duplicates. According to another embodiment, duplicate results may be detected with reference to the user associated with the result and other metrics, e.g., identical scores for the individual chat line for Readability and Goodwill.

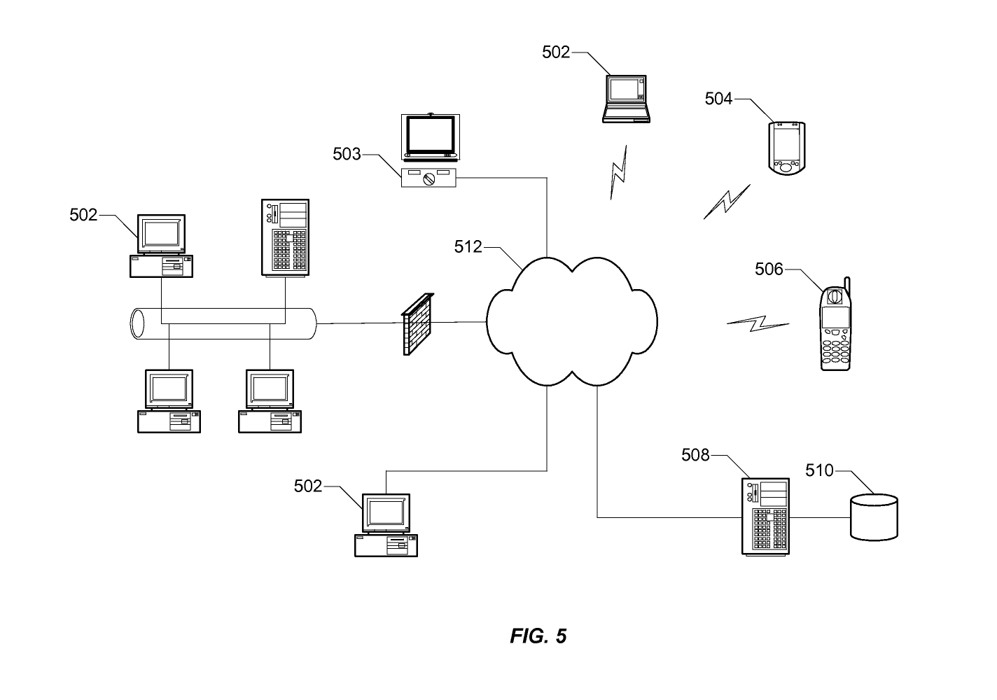

Embodiments of the present invention may be employed to record and index chat content, and to rank and present chat search results in any of a wide variety of computing contexts and using any of a wide variety of technologies. For example, as illustrated in FIG. 5, implementations are contemplated in which the relevant population(s) of users (e.g., either or both of chat participants and searchers of chat content) interact(s) with a diverse network environment via any type of computer (e.g., desktop, laptop, tablet, etc.) 502, media computing platforms 503 (e.g., cable and satellite set top boxes and digital video recorders), handheld computing devices (e.g., PDAs) 504, cell phones 506, or any other type of computing or communication platform. The operation of chat rooms, the recording and indexing of content, and the ranking and presentation of search results are represented in FIG. 5 by server 508 and data store 510 which, as will be understood, may correspond to multiple distributed devices and data stores operated by one or more entities. Server 508 and data store 510 may also represent an associated conventional search engine and related functionalities.

The invention may also be practiced in a wide variety of network environments (represented by network 512) including, for example, TCP/IP-based networks, telecommunications networks, wireless networks, etc. In addition, the computer program instructions with which embodiments of the invention are implemented may be stored in any type of computer-readable media, and may be executed according to a variety of computing models including a client/server model, a peer-to-peer model, on a stand-alone computing device, or according to a distributed computing model in which various of the functionalities described herein may be effected or employed at different locations.

While the invention has been particularly shown and described with reference to specific embodiments thereof, it will be understood by those skilled in the art that changes in the form and details of the disclosed embodiments may be made without departing from the spirit or scope of the invention. For example, embodiments of the invention are contemplated in contexts other than chat rooms using bodies of data which are not necessarily limited to lines of chat. That is, virtually any body of recorded data which shares at least some of the characteristics of chat data may be indexed and searched according to the present invention. One example of such a body of data may include accumulated communications generated by a voice communication system (e.g., a teleconferencing system) which might be captured, for example, using speech-to-text conversion. Another example of such a body of data may be the accumulated recordings of a group of court room stenographers. Yet other examples include captured text from virtually any channel of audio voice communications, e.g., streaming audio of “talk radio,” or a transcription of a script. Any transcription of real-time communications may be suitable for use with the present invention. Other suitable bodies of data will be apparent to those of skill in the art.

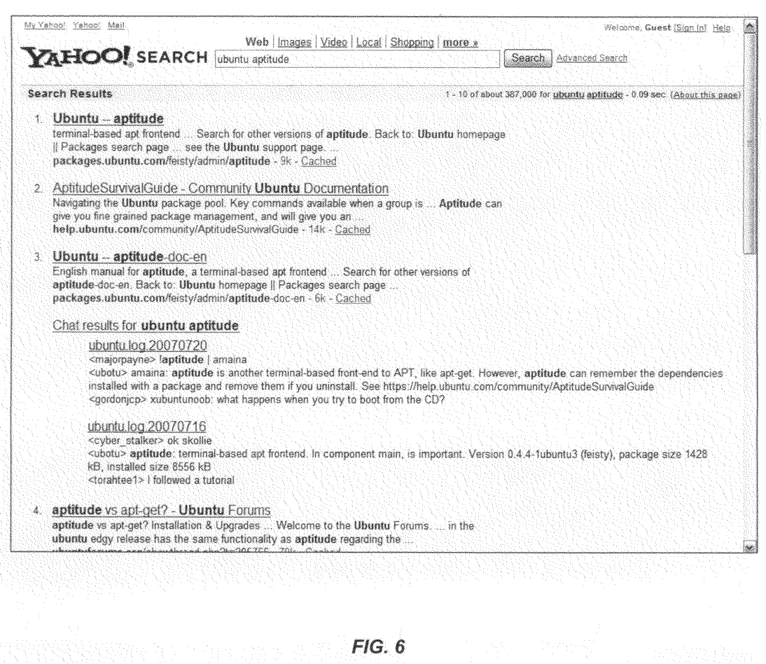

The search capability enabled by the present invention may also be provided in a variety of contexts. For example, search results corresponding to lines of chat and ranked according to the techniques described herein may be included among or in conjunction with conventional search results generated by a search engine (e.g., see chat results associated with search result number 3 in FIG. 6). Alternatively, such a search capability may be provided as a stand alone service on the Web exclusively focused on chat data or some other suitable body of data. As yet another alternative, such a search capability may be included in association with a chat room or group of chat rooms. As still another alternative, such a search capability may be included in conjunction with software which generates a body of communications suitable for use with such a search capability, e.g., instant or text messaging, or email software.

In addition, although various advantages, aspects, and objects of the present invention have been discussed herein with reference to various embodiments, it will be understood that the scope of the invention should not be limited by reference to such advantages, aspects, and objects. Rather, the scope of the invention should be determined with reference to the appended claims.

What is claimed is:

1. A computer-implemented method for facilitating searching of a body of data representing a plurality of communications, each of the plurality of communications being generated by an associated entity, the method comprising:
identifying a plurality of search results with reference to a keyword search initiated by a user, each search result corresponding to at least one of the communications;
ranking the search results with reference to at least one metric representing the associated entity who generated the corresponding communication; and
presenting the ranked search results to the user.

2. The method of claim 1 wherein the at least one metric comprises represents an authority level of the associated entity in a context in which the corresponding communication was generated.

3. The method of claim 2 wherein the authority level is determined with reference to one or more of readability of content generated by the associated entity, a frequency of activity by the associated entity in the context, or a measure of goodwill by which the associated entity may be characterized.

4. The method of claim 1 wherein ranking the search results is done with reference to at least one additional metric representing the corresponding communication without regard to the associated entity.

5. The method of claim 4 wherein the at least one additional metric comprises one or more of readability of content associated with the corresponding communication, a measure of goodwill by which the corresponding communication may be characterized, or a context in which the corresponding communication was generated.

6. The method of claim 1 wherein the plurality of communications comprise lines of chat generated in one or more chat rooms.

7. The method of claim 1 wherein selected ones of the search results represent additional ones of the communications associated with the corresponding communication in a context in which the corresponding communication was generated.

8. The method of claim 7 wherein ranking the selected search results is done with reference to at least some of the additional communications.

9. The method of claim 1 further comprising providing access to a representation of an original context of a first one of the communications in response to selection of the corresponding one of the search results.

10. The method of claim 1 wherein selected ones of the search results represent multiple, distinct ones of the communications which are characterized by substantially similar content.

11. A computer program product for facilitating searching of a body of data representing a plurality of communications, each of the plurality of communications being generated by an associated entity, the computer program product comprising at least one computer-readable medium having computer program instructions stored therein configured to enable at least one computing device to:
identify a plurality of search results with reference to a keyword search initiated by a user, each search result corresponding to at least one of the communications;
rank the search results with reference to at least one metric representing the associated entity who generated the corresponding communication; and
present the ranked search results to the user.

12. A computer-implemented method for generating a searchable body of data representing a plurality of communications, each of the plurality of communications being generated by an associated entity, the method comprising:
recording each of the plurality of communications;
for each of the plurality of communications, generating user metadata identifying the associated entity who generated the corresponding communication, and including a score for the associated entity, the score representing an authority level of the associated entity in a context in which the corresponding communication was generated; and
indexing the plurality of communications and the user metadata in a searchable data store.

13. The method of claim 12 wherein the score is determined with reference to one or more of readability of content generated by the associated entity, a frequency of activity by the associated entity in the context, or a measure of goodwill by which the associated entity may be characterized.

14. The method of claim 12 further comprising, for selected ones of the plurality of communications, generating line metadata representing the corresponding communication without regard to the associated entity.

15. The method of claim 14 wherein the line metadata are determined with reference to one or more of readability of content associated with the corresponding selected communication, a measure of goodwill by which the corresponding selected communication may be characterized, or the context in which the corresponding selected communication was generated.

16. The method of claim 12 wherein the plurality of communications comprise lines of chat generated in one or more chat rooms.

17. A computer program product for generating a searchable body of data representing a plurality of communications, each of the plurality of communications being generated by an associated entity, the computer program product comprising at least one computer-readable medium having computer program instructions stored therein configured to enable at least one computing device to:
record each of the plurality of communications;
for each of the plurality of communications, generate user metadata identifying the associated entity who generated the corresponding communication, and including a score for the associated entity, the score representing an authority level of the associated entity in a context in which the corresponding communication was generated; and
index the plurality of communications and the user metadata in a searchable data store.

18. A computer-implemented method for facilitating searching of a body of data representing a plurality of communications, each of the plurality of communications being generated by an associated entity, the method comprising:
enabling a user to initiate a keyword search of the body of data; and
presenting a plurality of ranked search results to the user, each search result corresponding to at least one of the communications, the search results having been determined with reference to the keyword search, and ranked with reference to at least one metric representing the associated entity who generated the corresponding communication.

19. The method of claim 18 wherein the at least one metric comprises represents an authority level of the associated entity in a context in which the corresponding communication was generated.

20. The method of claim 19 wherein the authority level was determined with reference to one or more of readability of content generated by the associated entity, a frequency of activity by the associated entity in the context, or a measure of goodwill by which the associated entity may be characterized.

21. The method of claim 18 wherein ranking of the search results was done with reference to at least one additional metric representing the corresponding communication without regard to the associated entity.

22. The method of claim 21 wherein the at least one additional metric comprises one or more of readability of content associated with the corresponding communication, a measure of goodwill by which the corresponding communication may be characterized, or a context in which the corresponding communication was generated.

23. The method of claim 18 wherein the plurality of communications comprise lines of chat generated in one or more chat rooms.

24. The method of claim 18 wherein selected ones of the search results represent additional ones of the communications associated with the corresponding communication in a context in which the corresponding communication was generated.

25. The method of claim 24 wherein ranking of the selected search results was done with reference to at least some of the additional communications.

26. The method of claim 18 further comprising presenting a representation of an original context of a first one of the communications in response to selection of the corresponding one of the search results.

27. The method of claim 18 wherein selected ones of the search results represent multiple, distinct ones of the communications which are characterized by substantially similar content.

28. At least one computer-readable medium having a data structure stored therein, the data structure comprising a plurality of data records, each data record corresponding to a communication generated by an associated entity and including at least a portion of the corresponding communication, each data record also having user metadata associated therewith, the user metadata identifying the associated entity who generated the corresponding communication, and including a score for the associated entity, the score representing an authority level of the associated entity in a context in which the corresponding communication was generated, wherein the data records are configured to be returned as search results, and the search results may be ranked with reference to the score for the associated entities.

29. The at least one computer-readable medium of claim 28 wherein the score represents one or more of readability of content generated by the associated entity, a frequency of activity by the associated entity in the context, or a measure of goodwill by which the associated entity may be characterized.

30. The at least one computer-readable medium of claim 28 wherein selected ones of the data records have line metadata associated therewith representing the corresponding communication without regard to the associated entity.

31. The at least one computer-readable medium of claim 30 wherein the line metadata represent one or more of readability of content associated with the corresponding selected communication, a measure of goodwill by which the corresponding selected communication may be characterized, or the context in which the corresponding selected communication was generated.

32. The at least one computer-readable medium of claim 28 wherein the plurality of communications comprise lines of chat generated in one or more chat rooms.
